(19) United States
(12) Patent Application Publication
(10) Pub. No.: US 2012/0054716 A1
(43) Pub. Date: Mar. 1, 2012

(54) DEPLOYMENT METHOD AND DEVICE AND ASSISTANCE IN DEPLOYING COMPONENTS FORMING AN EMBEDDED REAL TIME SYSTEM

(75) Inventors: Franck TAILLIEZ, LEOGNAN (FR); Martin DEFOUR, CROISSY S/SEINE (FR)

(73) Assignee: THALES, NEUILLY-SUR-SEINE (FR)

(21) Appl. No.: 13/216,815

(22) Filed: Aug. 24, 2011

(30) Foreign Application Priority Data
Aug. 24, 2010 (FR) 1003437
Dec. 14, 2010 (FR) 1004872

(51) Int. Cl. G06F 9/44

(52) U.S. Cl. 717/107; 717/120

(57) ABSTRACT

A technique for deploying components of a system on at least one platform comprising a number of processors, the technique including-formalization of a component description file for each component of the system, of a description file for an assembly of the components, of a description file for a deployment of the executables corresponding to the components on the processors of the platforms, of a file for mapping the components with executable tasks; generation of the software code of the containers for the components; generation of the definition and of the software code of the executable tasks corresponding to the components and to the containers; and production and implementation of the executables on the processors of the platforms.

The present invention relates to a method and a device for deploying, and assisting in the deployment of, components forming an embedded real time system. This invention applies notably in the field of software engineering applied to the design and implementation of complex embedded real time computer systems such as a flight computer embedded on board aircraft.

A complex embedded real time computer system is a computer system comprising multiple software components, said software components being able to be run on one or more computers. The real time software must satisfy significant constraints in terms of response time. Furthermore, the field of embedded software imposes limitations in terms of the physical size of the computers on which the systems are implemented. These size constraints are reflected at the software level in terms of performance. In practice, the more computation resources a system requires to run, the greater is the number of computers. It is therefore crucially important to be able to manage the computation resources available on board a mobile in an optimum way.

Software engineering is involved in all the phases of creation, implementation and production of a product, said product possibly being a software component or a complex software system. The software engineering is involved notably in phases of analysis of an operational requirement that the system must satisfy in order to establish a specification for the implementation of the system. Once the requirement is clearly identified, system specifications are drawn up. The specifications of the system are first of all drawn up at high level then with an increasingly fine level of definition detail to culminate in a definition of the implementation code for the various components of the software system. Then, the code is produced, followed by the production of the executable software. During all the specifications, design and as well as the original specifications. One of the aims of software engineering is to ensure that the final system satisfies the initial constraints and specifications.

To ensure that the system satisfies the constraints and specifications throughout its design and development cycle, it is necessary to check the predictive dynamic behaviour of the system. To check the predictive character of a system, it is necessary to formalize and check the cooperation mechanisms between the components of a software system designed on the basis of a system architecture.

Currently, in the field of software systems based on component architecture, there are solutions based on CORBA, Component Model or Enterprise Java Beans. CORBA is an acronym which stands for Common Object Request Broker Architecture and Component Model is what its name implies. CORBA is a software architecture, for the development of components and of Object Request Broker. Enterprise Java Beans, or EJB, is also a component architecture, seen from the server side. Solutions based on CCM, an acronym standing for Corba Component Model, and based on EJB, primarily offer communication mechanisms of event type or of service type to make software components cooperate.

The solutions based on CCM or EJB are extremely limiting from a cooperation mechanism point of view. In practice, it is, for example, not possible to define mechanisms of the data sharing type. Mechanisms of data sharing type are therefore conducted through service-type mechanisms. Now, in the context of embedded real time systems, software applications share data and collaborate hugely around data which constitute their main articulation. For example, a formalization of cooperation between equipment in the aeronautical domain is done by the production of ICD describing all the data exchanged. ICD is an acronym for Interface Control Document. To configure the use of these services, certain qualities of service exist. Quality of service, QoS, is a capacity to convey, in the correct conditions, a given type of traffic, in terms of availability, rate, transmission delays, data packet loss rate and response time. Response time constraints can, for example, be included by means of a definition of an interruptibility of the cooperations between components, an allocation of components that are sensitive in terms of response time to real time tasks. An interruptibility is a capacity to be interrupted. Among the existing qualities of service, none allows for the specification of rules concerning the real time behaviour of the software system and its projection or use on resources of a computation platform.

Furthermore, the inclusion of response time constraints is either the responsibility of the component developers, or the responsibility of the developers of a container encapsulating the components. However, more often than not, the inclusion of the response time-type constraints is opaque with respect to the underlying logic implemented.

It should also be noted that very often there is no flexibility in the connection of the event- or service-type operations between software components. The interconnection of the components is achieved by an allocation of event interface or service interface to components acting as producer and consumer. This therefore imposes a name identity between the interface proposed by a producer and the interface requested by the consumer. This identity is difficult and clumsy to manage.

To ensure that the system satisfies the initial constraints and specifications, it is also necessary to be able to evaluate the performance of the software system from the early system design phases. To evaluate the performance levels of a software system that has not been produced, there are notably two approaches.

A first approach relies on a macroscopic evaluation of an overall complexity of the software components from which is deduced an estimation of the time that a software component will take to run on a computation platform, said computation platform possibly consisting of one or more computers. This first approach relies on feedback concerning the operation of known systems. This first approach is simple to implement but the accuracy of the results obtained is not sufficiently accurate. An approximation of the computation power induced may be sufficient but evaluating compliance with the response times imposed by the real time constraint relies on a lot of assumptions, notably assumptions regarding the implementation of the software according to development rules which are in most cases unverified.

A second approach relies on a simulation of the software system. Such a simulation is based on a software coding of portions of the algorithms implemented by the system. For this second approach, the quality of the estimations is very highly dependent on the fineness of the simulation concerning the real future behaviour of the system. One of the main risks in such an approach is of ultimately carrying out a very detailed simulation ahead of phase in the production of the system, which is very costly in terms of software development. There is in fact a risk of predeveloping the system in detail, simply to predict performance levels.

One aim of the invention is notably to overcome the above-mentioned drawbacks. To this end, the subject of the invention is a method for deploying components of a complex system on at least one platform comprising one or more processors. The method comprises at least the following steps:
generation of a component description file for each component of the complex system, said file comprising a description of the operations and data, incoming and outgoing to and from the component;
generation of a description file for an assembly of the components to form the complex system;
generation of a description file for a deployment of the executables corresponding to the components on the processors of the platforms;
generation of a file for mapping components with executable tasks, each task corresponding to at least one component, based on the component description, assembly description and deployment description files;
generation of software code for containers of the components, each component being encapsulated by a container, said container comprising all the interfaces between the component and the complex system and between the component and the other components of the complex system, based on the file for mapping the components with executable tasks;
generation of executable tasks software code corresponding to the components and to the containers;
production of the executables by assembly of the executable task code, the containers code and the code of the components associated with each executable;
implementation of the executables on the processors of the platforms on the basis of the deployment file.

Advantageously, the method may also comprise a step for checking the syntax and semantics of the component description files, assembly description files, deployment description files.

The method may also comprise a step for checking consistency between the component, assembly and deployment description files.

The method may comprise a step for modifying the component, assembly and deployment description files when a file consistency error is detected during the consistency checking step or during the step for checking the syntax and semantics of the abovementioned files.

The generated files notably follow a predefined grammar.

The files are, for example, generated in xml format, xml being an acronym for Extensible Markup Language.

The xml files may be generated according to an xsd model, xsd being an acronym for xml Schema Description.

Also the subject of the invention is a device for deploying components of a complex system on at least one platform comprising one or more processors. The device comprises at least:
a means for generating a component description file for each component of the complex system, said file comprising a description of the operations and data, incoming and outgoing to and from the component;
a means for generating a description file for an assembly of the components to form the complex system;
a means for generating a description file for a deployment of the executables corresponding to the components on the processors of the platforms;
a means for generating a file for mapping the components with executable tasks, each task corresponding to at least one component, based on the component description, assembly description and deployment description files;
a means for generating software code for containers of the components, each component being encapsulated by a container, said container comprising all the interfaces between the component and the complex system and between the component and the other components of the complex system, based on the file for mapping the components with executable tasks;
a means for generating software code for the executable tasks corresponding to the components and to the containers;
a means for producing executables by assembly of the executable task code, the container code and the code of the components, for each executable;
a means for implementing executables on the processors of the platforms on the basis of the deployment file.

The device may also comprise a means for checking the syntax and semantics of the component description files, the assembly description file and the deployment description file.

The device may also comprise a means for checking consistency between the component, assembly and deployment description files.

Also the subject of the invention is a method for evaluating performance levels in a deployment of components of a complex system on at least one platform comprising one or more processors. The evaluation method comprises at least the following steps:
generation of a component description file for each component of the complex system, said file comprising a description of the operations and data, incoming and outgoing to and from the component, said file describing a modeling of the operation of the component in terms of processing time;
generation of a description file for an assembly of the components to form the complex system;
generation of a description file for a deployment of the executables corresponding to the components on the processors of the platforms;
generation of a file for mapping the components with executable tasks, each task corresponding to at least one component, based on the component description, assembly description and deployment description files;
generation of a description file of a scenario for execution of a simulation of the complex system, implementing the modelings of the components;
virtual execution of the scenario and time analysis of the processing operations carried out by the modeled components;
inclusion of the analysis in the description of the components, of the assembly of the components, of the deployment of the components of the complex system.

The invention also relates to a device for evaluating performance levels in a deployment of components of a complex system on a platform comprising one or more processors. The evaluation device comprises at least:
a means for generating a component description file for each component of the complex system, said file comprising a description of the operations and data, incoming and outgoing to and from the component, said file describing a modeling of the operation of the component in terms of processing time;
a means for generating a description file for an assembly of the components to form the complex system;
a means for generating a description file for a deployment of the executables corresponding to the components on the processors of the platforms;
a means for generating a file for mapping components with executable tasks, each task corresponding to at least one component, based on the component description, assembly description and deployment description files;
a means for generating a description file of a scenario for execution of a simulation of the complex system, implementing the modelings of the components;
a means for virtual execution of the scenario and time analysis of the processing operations carried out by the modeled components.

The main advantages of the invention are notably that it allows for a control and regular tracking of the system during the various system design and development phases. Said control makes it possible to check that the requirements and specifications that the system must satisfy are indeed satisfied. In particular, the observance of the response time requirements and the use of physical resources such as different processors of a platform can be controlled throughout the system design and development process.

Other features and advantages of the invention will become apparent from the following description, given as a nonlimiting illustration and in light of the appended drawings which represent:

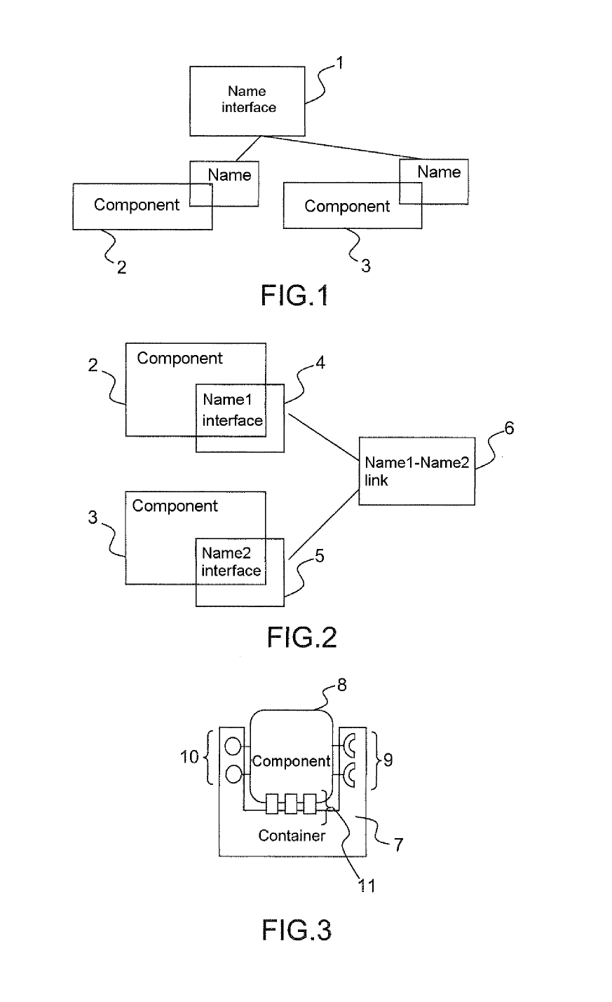

FIG. 1: an example of component level interface production according to the state of the art;

FIG. 2: an example of component level interface production according to the invention;

FIG. 3: a container according to the invention;

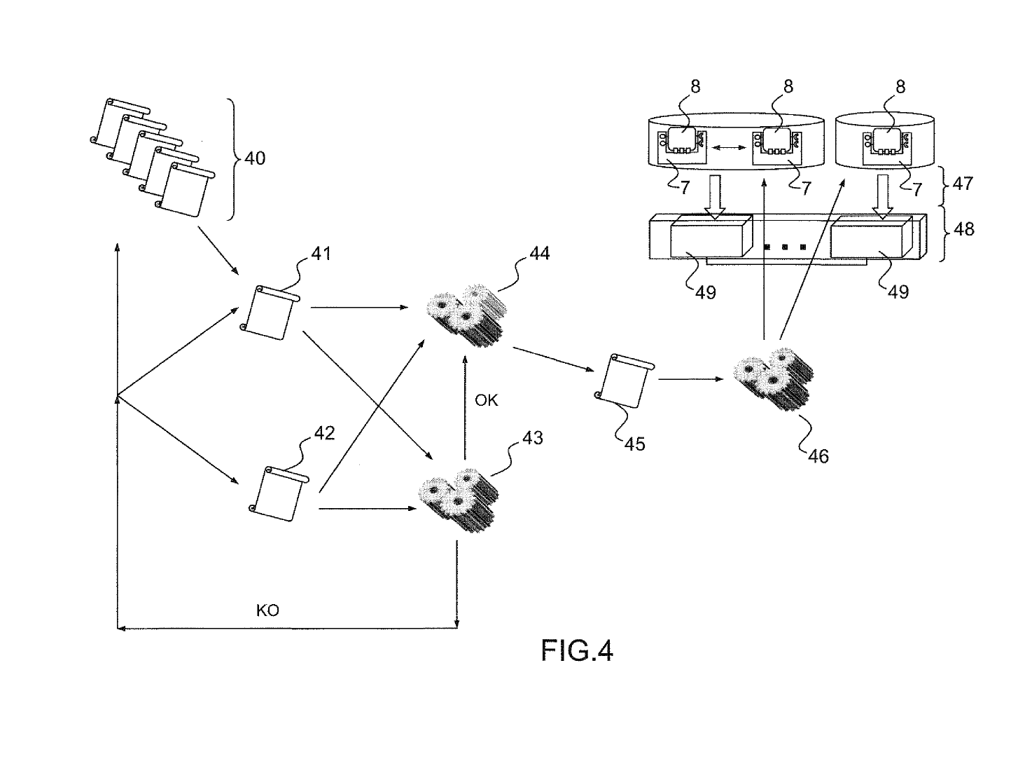

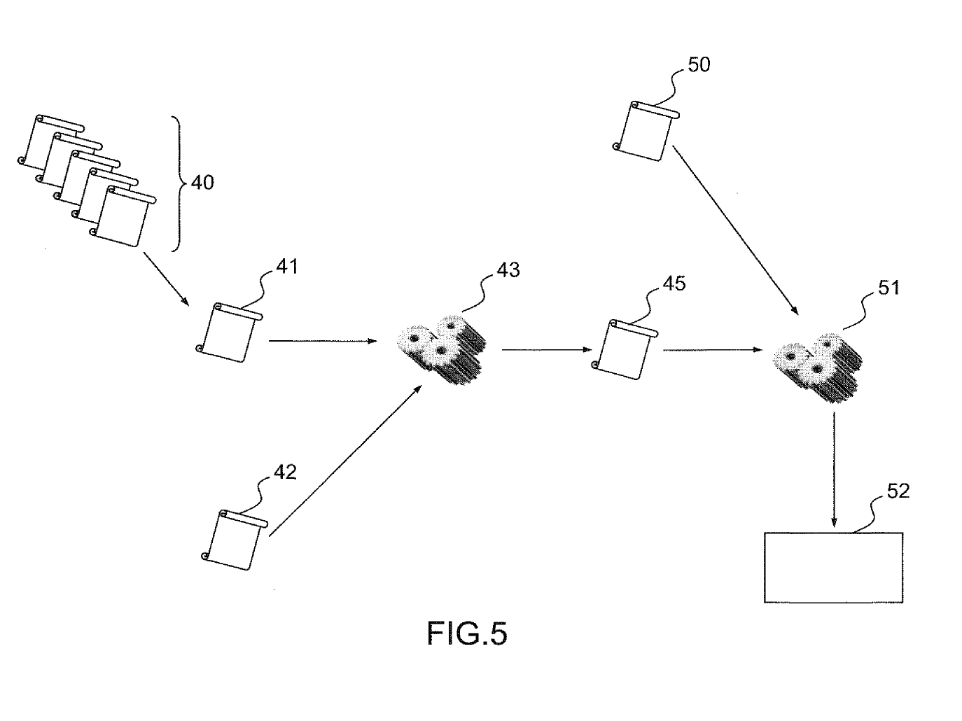

FIG. 4: an example of a method for deploying components of a complex system according to the invention;

FIG. 5: an example of a method for evaluating the performance levels of a complex system according to the invention.

FIG. 1 represents an example of the production of interfaces between components of a system, according to the state of the art. Producing complex embedded real time systems often demands a breakdown of the system into a number of embedded real time components of said system. Physical connections between the components are provided by connections via sockets and TCP/IP or UDP/IP ports. The sockets are network connectors. TCP, UDP and IP are communication protocols, TCP being an acronym for Transmission Control Protocol, UDP being an acronym for User Datagram Protocol and IP being an acronym for Internet Protocol. A real time task is created by the system for each of the components. Each component cooperates with one or more other components of the system by means of one or more interfaces. To this end, and for example, a first interface 1 may be defined. The first interface 1 may comprise at least one identifier denoted “Name” in FIG. 1. Components 2 and 3 of the system that have to cooperate must, for this, implement the first interface 1. That is to say that the components 2, 3 must implement the arguments and the prototype of the first interface 1. Thus, the first component 2 implements the first “Name” interface and the second component also implements the first “Name” interface. Thus, during the design phase, it is necessary for all of the people responsible for the development of each component to agree on the first interface 1, in order to decide on a common implementation of the first interface 1, satisfying the requirements of each component. Then, each component must implement all the interfaces with the other components to which it is connected. There is therefore no flexibility in the definition of interfaces at the system architecture level. It is then difficult for the architects of the system to control the evolution of the architecture of the system both during its design and during its implementation, and even for its future upgrades. Such systems are therefore very difficult to upgrade. In practice, on each upgrade for which the interfaces have to be modified, each component using the modified interface must take account of this modification. Furthermore, each interface modification induces edge effects on the operation of the system. These edge effects are neither predictable nor controllable. For example, an elimination of an argument in an interface method, said argument not a priori being used, may lead to a series of errors for which the a priori cause may be difficult to identify. In practice, a functionality of a component may, counter to all expectations, use the eliminated argument. Furthermore, bug fixes at the level of an interface of the system, by someone with no control over all of the components using this interface, may introduce an instability that is difficult to predict in the code of the system.

FIG. 2 represents an example of interface production at the level of a component, according to the invention. One principle of the invention relies on a definition of an interface 4, 5 at the level of each component 2, 3. For example, depending on its requirements, the first component 2 may comprise a second interface 4 identified by “Name1”. The second component may comprise a third interface 5 identified by “Name2”. Since the second and third interfaces 4, 5 are able to cooperate with one another, they may be linked together by an architect of the system. This link may be formalized by a Link, identified, for example, by “Name1-Name2”. The link may be set up after one or more syntax checks, semantics checks and consistency checks from the two interfaces 4, 5 to be linked. Advantageously, such an interface definition allows each component to be independent of the other components with which it is linked. Thus, for example, name changes at the level of the interfaces of a component have little or no influence on the interfaces of the other components of the system.

FIG. 3 schematically represents a container 7 according to the invention. Each component 8 of the system may be encapsulated by a container, providing the interface with other components of the system via their respective container. Thus, for each component, the interfaces that it needs are defined, independently of one of the components. The container implements a software overlayer necessary to the integration of the component 8 in the system. The container is middleware, automatically generated by a container generation tool, from XML contract description files, as defined hereinbelow. An XML file is a file written in a generic markup computer language, XML being an acronym for Extensible Markup Language. The interfaces between the different components via their container must have the same signature, that is to say, the same physical data types, but not necessarily the same data names or data type name as represented in FIG. 2. The constraint of identity between the signatures of the interfaces can be checked automatically by a suitable syntax and spelling checking tool.

Several types of interfaces can be defined between a component and its container. For example, the following may be defined:
interfaces 9 requested for the operation of the component, these interfaces enabling the component to retrieve data, information necessary to its operation;
interfaces 10 supplied by the component, enabling data and information originating from results of functional processing operations performed by the component to be transmitted to the system;
operating interfaces 11, enabling the component to accept commands originating from the system such as a start, stop command, and to supply the system notably with information on the state of operation of the component, for example: normal operation, degraded operation, stop.

The component itself includes only the functional processing operations independently of the system and of the other components of the system. The component can therefore be developed and implemented independently of the system. Implementing a component notably comprises generation of the functional code of the component. The generation of the functional code of the component may be manual. Non-functional processing operations which are highly dependent on the system are handled by the container. The container thus supports all the variability of operation of the component with the system, which allows for management and simple integration of heterogeneous components in one and the same system.

Advantageously, such an encapsulation of components therefore makes it possible to compose a system from existing components previously constructed according to the present invention. Advantageously, the inclusion of new components in the system or the modification of a component of the system has little impact on the other components: the connection of the interfaces being totally unconnected with the functional parts of the components.

FIG. 4 represents an example of a method for deploying components of a complex system according to the invention.

During a first step of the deployment method according to the invention, each component of the system may be described according to a grammar defined by an XSD model. An XSD, or XML Schema, model is an XML document format description language. The XSD model makes it possible to define a structure for the XML document. The XSD model thus defines a component description language. The component description language makes it possible to formalize different types of cooperations that might exist between the components of the system. For example:
an event-type cooperation, said events being defined by a signal or a stimulus from one or more producing components to one or more consuming components;
a message-type cooperation, said message comprising a signal and data, produced by one or more producing components for one or more consuming components;
a data publication/read-type cooperation, that is to say, a provision of data by a component so that these data are read by one or more other components. In this case, there are one producing component and one or more consuming components;
a service-type cooperation, that is to say, a processing operation carried out by a component for another component, in this case, there is one producing component and one consuming component.

Advantageously, a use of event and service type mechanisms and a versioned data sharing mechanism makes it possible to guarantee a time-related consistency of the data throughout the data access time, notably by defining a quality of service associated with the publication of data. Versioned data are data which are assigned a version number as soon as they change, while retaining the data in its initial form associated with its version number. Thus, retaining several data versions makes it possible to retrieve a version more easily even after more recent versions of the data have been put in place. A quality of service is, for example, a capacity to convey, in the right conditions, a type of traffic, in terms of availability, bit rate, transmission delay, data packet loss rate, response time. The time consistency of the data is ensured by the fact that when a datum is read, the reading component is assigned the latest version of the datum produced by the producing component. The version of the datum assigned to the reader is kept stable and fixed in a first buffer for the consuming/reading component even if the producing component in the meantime produces a new version of the datum. In practice, the producing component is assigned a second data buffer for the production of a new version of the datum. When the consumer/reader “releases” the version that it was using, if no other consumer uses it, this version and the first buffer associated with it are released and the first buffer becomes available again for the producing component. This type of management provides two major advantages in terms of observing real time constraints:
there is no blocking or priority inversion between the producing components and the consuming components: for example, a blockage may occur because of a mutex, a mutex being a technique used in computing to obtain exclusive access to shared resources, the producing component can therefore still produce data even if a consuming component uses the produced datum;
it is possible to calculate an overall number of buffers for all the consumers and for the producer in the entire system in order to avoid dynamic memory allocation mechanisms whose production times are not always deterministic.

A description of the cooperations between components can be produced via a cooperation description tool. The tool for describing cooperations between components of the system generates an XML file, which may be called component contract. A component contract notably makes it possible to define the relationships that exist between different types of components in a system.

A component contract may, for example, be defined by:
a component type long identifier;
a component type short identifier;
possibly, a system component type: for example supervisor, system clock;
a class defining, for example, whether the component is active or passive;
a language for coding the source code of the component.

Each active component is mapped with a single task. A first active component notably performs processing operations on receipt of a wake-up call by request or event type operations. The first active component may request one or more services of a second passive component. The first active component may also request one or more services of a third active component associated with a task with an execution priority greater than or equal to the execution priority of the task associated with the first active component.

A fourth passive component may be, for example, a multitasking re-entrant component. Re-entrance in computing is the propensity for a function of a component to be able to be used simultaneously by several tasks. The fourth passive component may therefore be called by several other components simultaneously. The fourth passive component supplies, notably, services to the other components, whether they are active or passive.

A component contract may define different operations or cooperations between components, notably by:
types of data exchanged;
possibly, instance specialization attributes;
a definition of operations: outgoing or incoming operation, with a description depending on type:
   a service-type operation being able to be defined by: a service identifier, input parameters, output parameters;
   a data publication-type operation that may be defined by: a name, data;
   an event-type operation that may be defined by a named signal without parameters;
   a request or message-type operation, which may be defined by a signal identified by a name taking one or more parameters as input.

For example, a cyclical wake-up of a component can be implemented by means of a wake-up-type event. All the possible types of interactions between the components can therefore be described on the basis of the basic cooperation types defined above.

The first step of the method according to the invention is therefore a step for definition of component contracts 40 according to the invention. This definition of component contracts may be carried out using a contract definition method well known to those skilled in the art. A contract description tool notably makes it possible to implement the contract definition method by generating contracts 40 in the form of XML files. For example, it is possible to use existing UML modelers, UML being an acronym for Unified Modelling Language. The existing UML modelers can be adapted to the context of the present invention to supply interfaces as represented in FIG. 2. Advantageously, the formalization of all the cooperations produced and consumed by a component, independently for each component, makes it possible to make the components independent of one another.

A second step of the method according to the invention may be a step for definition of an assembly of the components 40. The result of the assembly is notably an assembly XML file 41, or assembly contract 41, notably comprising the following information:
an assembly identifier;
for each component type:
   the component contract;
   the instances of the component, and for each component instance:
      one or more identifiers;
      possibly attributes: for example, instance parameters.

The instance parameters may be parameters allowing for a specialization of an instance of a component.

A component assembly file, also called assembly contract, may also comprise a description of links between the instances and, notably, for each link:
the link type: service, data publication, event, request;
for a service-type link:
   at least one identifier;
   at least one producing component, and the name of the interface seen by the producer;
   at least one consuming component, and the name of the interface seen by the consumer.

The XML assembly file is notably generated according to a previously defined grammar. The XML assembly file may also be generated automatically by a component assembly method, said assembly method taking as input the component contract definition file or files and the component assembly information mentioned above.

A third step of the method according to the invention may be a step for definition of a deployment 42 of executable files. The executable files implement instances of components as defined in the assembly file. An executable file may thus implement one or more instances of components, defined in the assembly file 41 for example. An executable file is a file containing a program written in machine language, directly executable by a processor and enabling an application to be run. Each executable file, or more simply each executable, is generated by a compiler from the functional code of a component and from code generated automatically by tools allowing for the implementation of the method according to the invention: notably, the code generated for the containers of components, code generated for the executable tasks. An executable is therefore specific to a software language used to code the component. The step for definition of a deployment makes it possible to produce an XML deployment file 42 comprising the information necessary to the deployment of the executables of the instances of the components on the different platforms of the system. The deployment file 42, or deployment contract, notably comprises the following information:
at least one deployment identifier;
at least one target platform.

A platform is a computation resource equipped with an operating system. A platform may comprise one or more computation processors. The step for definition of a deployment 42 uses as input data the component contracts 40 defined previously.

A platform may be defined by the following characteristics:
at least one identifier;
a resource group identifier;
a production type;
an operating system;
an endianism, that is to say, an order of organization of the bytes defining a whole in a communication or in a memory: the two possible endianisms are called little-endian and big-endian, but these terms are little used;
an IP address: address of the platform in a network;
a first socket number: the start of a range of socket numbers available for a computation of the routings between platforms;
a second socket number: the end of the range of the socket numbers available for the computation of the routings between platforms;
shmin, shmax: which respectively represent a minimum number and a maximum number of shared memories which can be used for the definition of the event queues, requests, demands, service returns, sharing of data between all the components local to a platform;
a minimum execution priority: that is to say, a minimum value of the priority available on the platform for the computation of the priorities of the real time tasks by observing a hierarchy of the response times desired for the components;
a maximum execution priority corresponding to a maximum value of the priority available on the platform, said priority of the real time tasks being computed in accordance with the hierarchically-organized desired response times;
at least one distribution, that is to say, a name of an executable used to route data packets via a UDP/IP protocol from other platforms to components local to this platform, said data packets containing events, requests, service demands, service responses, data publications, UDP-IP being an acronym standing for User Datagram Protocol;
at least one implementation panel, that is to say, an IP address that allows communication with the system operation management software, said software making it possible to transmit to the system commands to start, suspend, restart, stop one or more components;
at least one command panel, that is to say, a number of a socket via which commands are received from the implementation panel;
at least one response panel, that is to say, a socket number to which execution reports are sent concerning the state of execution by the system of the commands that it has received;
at least one execution trace file defined by a socket number to which can be sent traces of the execution of the system for system debugging;
at least one display defined by a socket number to which can be sent information to be displayed originating from the various components running on this platform;
at least one identifier of the platform;
one or more executables running on the platform.

The executable or executables may be defined notably by:
at least one name;
at least one identifier;
an executable start command;
one or more instances of deployment of the components associated with this executable.

Each deployment instance may notably be defined by:
at least one name;
an end date corresponding to a need in terms of response time class;
at least one identifier.

The deployment contract 42 makes it possible to specify response time constraints for the components instantiated on each computation platform. For each component instance, a response time class is defined. The response time class of a component instance is associated with a task hierarchy defined in each executable that makes it possible to automatically compute the interruptibility, the parallelism of each of the components according to its requirement in terms of response time class. The parallelism is the ability of the component to be executed on one or more processors in parallel. This computation is carried out by an executables generation tool. Thus, from the deployment step, it is possible to specify a processing time class for each component. The description of the component, assembly and deployment contracts can be carried out using a tool for describing cooperations between components. The tool for describing cooperations between components may generate component 40, assembly 41 and deployment 42 contract description XML files.

A fourth step of the method according to the invention may be a step for checking consistency 43 of the assembly contracts 41, the deployment contracts 42, and a check on consistency between the assembly 41 and deployment 42 contracts. An automatic syntax, spelling and semantics checking tool may take as input the assembly 41 and deployment 42 contracts, in order to check their construction. For example, the consistency checking step 43 may comprise a check on the cooperations of the types of service between components to ensure that they do not lead to an instability of the real time system. A consistency check is notably applied to check that a first component does not synchronously call a service which is rendered by a second component whose response time class is greater than the response time class of the first component. In practice, if it is, the executable task associated with the first component requesting the service is suspended pending the response of the executable task associated with the second component rendering the service. In this case, there is a kind of priority inversion: a task associated with a component whose response time class is lower waits for a task associated with a component whose response time class is higher. It may be that the first component requesting the service can no longer observe its response time class. A consistency check may also be implemented between the assembly 41 and deployment 42 contracts. For example, such a check may detect the following problems:
a task priority inversion between a consuming component and a supplying component in the execution of their respective tasks, such an inversion possibly causing a system crash;
a mutual or crossed call for services between two separate tasks of components awaiting each other's results, such a mutual call may also result in a system crash;
in the case of an execution of the system on multiple platforms or on a single platform with a multicore processor, a crossed call for two different component tasks.

When errors in the definition of the contracts are detected, it is necessary to re-generate the contracts 40, 41, 42 in order to correct the identified errors. The method therefore resumes at the first step. If no consistency error is detected, then the next step of the method according to the invention takes place. Advantageously, such a fourth step makes it possible to detect as early as possible problems in the design of the components or of the system as a whole in order to correct them during a phase of the development cycle during which this type of correction is inexpensive. In practice, performing this type of correction once the system is deployed on a user site involves intensive modifications on a number of components which cannot be considered once the system is deployed on the platforms.

A fifth step of the method according to the invention is a step for computing a mapping of the components of the system with tasks running in real time. The mapping of the components with tasks takes into account the assembly 44 and deployment 45 contracts to define an allocation of the components to the execution tasks implemented by the processors of the platform. The allocation of the components to the tasks 44 generates a file defining the allocations of the components to the tasks 45. The allocation file 45 may be described according to an XML standard. The computation of a mapping of the components with the tasks is done by defining a task for each response time class and for each executable, associated with all the components that have the same response time class. The priority of the tasks is computed globally for all the tasks associated with executables of a platform by observing the overall hierarchy of the response times of all the components linked to all the executables of the platform. The allocation of the components to the tasks is also done by taking into account an order of execution of the processing operations of the components according to the different calls between components and according to the response time of each component. Thus, the order of execution of each component is predictive.

A sixth step of the method according to the invention is a code generation step 46. The code generation step 46 may be carried out automatically by a code generation tool, or code generator, taking as input the file mapping the components and tasks. The mapping file is an intermediate computation file for all the elements necessary to the generation of software code of the system and notably:
identification of the task names;
priorities for the tasks;
communication queue depths;
numbers of communication sockets between platforms.

The mapping file contains all the automatically computed data. The mapping file is used to generate the code of the system. The code generator thus creates all the types of data necessary to each component and the containers of each component from the component 40, assembly 41 and deployment 42 contracts and mapping of the components with the tasks. The code generator also produces a software code for the executable tasks corresponding to the components and to the containers. The processing time class defined in the deployment file 42 is taken into account by the code generation tools. The container is middleware, generated automatically, encapsulating a component with respect to the system and the other components. Each component 8 therefore knows only its own container 7. Thus, each component may be developed by disregarding the real connections, existing in the system with the other components. The component therefore interacts with the system via its container. Advantageously, the encapsulation of the components in containers makes it possible to have components coexist which:
run on different types of platform: such as a personal computer, a workstation;
use different coding languages;
run on platforms using different operating systems.

Advantageously, the containers are based on simple generic middleware which comprises:
generic interfaces allowing for the management of tasks, management of events, management of communication channels, management of time, for all the operating systems of the target platforms;
general mechanisms for producing versions of the data shared between components;
general request queue management mechanisms, that is to say, operations between components of event, request, service demand or service return type, between tasks;
general mechanisms for serialization and deserialization according to the endianism of the parameters of the operations being performed between the components, a serialization being an operation for encoding information which is in memory in the form of a series of bytes or of bits, a deserialization being the reverse operation.

Advantageously, the interfaces between the system and the component are therefore stable: support for the error cases generated by the components, that is to say, their recognition and processing, is handled at the container level.

A seventh step of the method according to the invention is a compilation step with a view to generating executables associated with the different components. A production of executable files is performed notably by assembling the code of the executable tasks, the code of the containers, the code of the components, the code of the components comprising a code portion generated automatically and a code portion which is purely functional and produced manually. The executables that are generated are then deployed on the different processors 49 with which the platform or platforms 48 are equipped according to the deployment file 42. The executables may thus be implemented by the different processors 49. Different executable tasks are defined for the container 7 of each component 8. The executable associated with the container 7 in turn manages the executable tasks that are assigned to it. The executable of the container 7 therefore calls services and functions of the component 8. Thus, it is possible to provide a time between two task executions that is independent of the size of the data processed by the two tasks, by using, for example, a description pointer for each task. Different qualities of service may, for example, be taken into account in the code of the container, the latter being able to provide mechanisms having, for example, a good interruptibility. The compilation step performs a translation of the generated code into binary language specific to the target platform.

Advantageously, the method according to the invention makes it possible to formalize the recognition of quality criteria then to propagate it during the phases of design, development and implementation of the executables specific to the components of the different systems.

Advantageously, the method according to the invention allows for an automatic instantiation of the software components in tasks observing a real time execution constraint, while observing a hierarchy compatible with the response time constraints expressed in the deployment contract 42 of the components.

Advantageously, the calls to the operating systems of the different platforms are taken into account by the containers of the components. The calls to the operating systems of the different platforms are performed by the executables implementing the tasks linked to the containers. Thus, the components are independent of the operating system of the platforms on which they are deployed.

Advantageously, the method according to the invention makes it possible to automatically dimension the size of the data exchange queues so that they are compatible with the different needs of the components. For example, the size of the parameters of all the operations can be computed, as can the maximum possible number of operations pending between the different components, by transforming, for example, the response time classes of each component into pseudo-frequencies and by comparing the pseudo-frequencies to find the maximum numbers of operations pending.

FIG. 5 represents an example of a method for evaluating a complex system according to the invention. The method for evaluating the system notably uses the following steps of the deployment method according to the invention:
the first step for describing each component of the system by the definition of a contract specific to each component 40 of the system;
the second step for defining an assembly 41 of the components;
the third step for defining a deployment 42;
the fifth step for computing the mapping of the components of the system with real time tasks 43, generating the allocation file 45.

The component contracts 40 may be complemented with a simplified formalization of the processing operations of the components according to a formal language, based on operations or stimuli that the component receives as input. An example of a simplified formalization may be to describe a consumption in terms of algorithmic complexity, of the processing operations carried out by the component, combined with requests for operations supplied as output from the component. For example, one or more behaviours may be defined in a component contract using the following parameters:
at least one behaviour identifier;
a relevant operating mode, for example: nominal mode, degraded mode, maintenance mode, the mode making it possible to define a different behaviour of the component according to each mode, a check on the observance of the response times being carried out for all the modes of all the components;
one or more stimuli triggering processing operations in the component, the events possibly being of the type: event, request, service demand;
for each stimulus, a simplified description of the processing operations implemented by the component comprising one or more of the following operations:
   an operation defined with an execution time;
   a computation defined by a maximum complexity;
   a reservation/release of a data access;
   a service call;
   an event transmission;
   a request transmission;
   one or more nested iterations on a computation, a reservation/release of a data access, a service call, an event transmission, a request transmission.

Each operation at the input of each component of the complex system can then be associated with a component behaviour description. The behaviour description is a modeling of the behaviour of the component in terms of computation power needed to perform each operation.

An exemplary description of a behaviour is given in Appendix 1, according to an XML formalism.

An eighth step of the evaluation method may be a step for defining a scenario for execution of the modelings of the components allowing for a performance analysis of the system 50. A performance analysis scenario 50 may, for example, comprise the following parameters defined, for example, according to a predefined XSD format:
a scenario identifier;
an operating mode for each instance of the components, for example nominal, degraded, stopped mode;
a modeling of a background noise by a series of operations, each operation having an activation period during which it will use resources of the platform;
one or more functional chains which represent sequences of stimuli addressed to components.

Advantageously, the modeling of a background noise at the level of the processing operations makes it possible to model processing operations performed cyclically by the system, without interruption.

An example of an xml file describing a performance analysis scenario is given by way of example in Appendix 2.

A ninth step of the evaluation method may be a step for virtually executing the execution scenario by the use of a tool for computing behaviours of the platforms and of the components on these platforms by using a simplified platform model. The simplified platform model notably has the capacity to take into account the complexity per second and the scenarios and the individual behaviours of each component on each stimulus. The behaviour computation tool guarantees identical operation between the model and the operational system software. In practice, a task scheduling module is used as input for the behaviour computation tool and on the real platforms is the same. A description of the behaviours of components for each stimulus, complemented by the simple model expressed in terms of complexity per second to represent the computation power required by the components is sufficient to be able to compute the maximum execution times, or worst case execution times (WCET), of the different functional chains and the rate of use of the processors of the different platforms for the different scenarios. The tool uses a computation engine to provide an animation of the components of the system, in the context defined by the scenario 50. Thus, the simulation platform may supply as output time analyses of the processing operations performed by the system 52. Notably, the stimulation platform may supply a Gantt chart of a sequencing of the processing operations carried out by the different components in time, an estimation of the computation powers used as a function of time by the system, a diagram of the functional chain response times.

Thus, the following results may, for example, be displayed on visualization means:
an overall computation power consumed on the computation platforms;
a distribution of the computation power consumed according to the different components;
a distribution of the computation power consumed according to the executables hosting the components;
a response time for the different computation chains;
a Gantt chart representing an activation of the different components in time.

Advantageously, the method for evaluating the system allows for a dimensioning of the resources, an optimization of the components throughout the development of the components and of the system. Thus, based on the results obtained by the evaluation method, the component, assembly and deployment contracts may be modified in order to improve the system performance levels. Advantageously, such an evaluation may be carried out even when the components are not yet developed, a modeling of their behaviour in terms of processing time according to the available resources being sufficient to evaluate the system.

The present invention applies notably to the field of embedded real time systems, such as flight computers embedded on board aircraft.

### APPENDICES

### Appendix 1

### Example of a Definition File of an Operational Scenario for Evaluating a Behaviour

<behaviour name=“Behaviour1” mode=“operational”>

<onevent name=“New_Objective_List” /> −
<block>

<getaccessdata name=“Objective_List” />
<getaccessdata name=“Sorted_Objective_List” /> −
<loop max=“3”>

<compute maxcomplexity=“1” />
<requestsend name=“Delete_Objective” />

</loop>
<compute maxcomplexity=“5” />
<servicecall name=“Distance3D2D” />
<compute maxcomplexity=“5” />
<servicecall name=“sqrt” />
<compute maxcomplexity=“2” />
<freeaccessdata name=“Objective_List” />
<freeaccessdata name=“Sorted_Objective_List” />
<eventemit name=“New_Sorted_Objective_List” />

</block>−
<block>

<compute maxcomplexity=“5” />

</block>

</behaviour>

### Appendix 2

### Example of a Definition File of an Operational Scenario for Evaluating Performance Levels

<performanceanalysis>
<scenario name=“nominal”>
<instancemode instancename=“SORT” mode=“operational” />
. . .
<instancemode instancename=“DISPLAY” mode=“operational” />
<operationperiod period=“100” operationid=“1014” />
<operationperiod period=“500” operationid=“1013” />
<operationperiod period=“700” operationid=“1019” />
<functionalchain name=“chain1” maxtime=“160” operationid=“1013”>
<step componentname=“STIMU” operationid=“1012” />
<step componentname=“ACQUIRE” operationid=“1010” />
<step componentname=“MANAGE” operationid=“1006” />
<step componentname=“SORT” operationid=“1008” />
<step componentname=“DISPLAY” operationid=“0” />
</functionalchain>
</scenario>
</performanceanalysis>

1. A method for deploying components of a complex system on at least one platform comprising one or more processors, said method comprising the steps of:
generating a component description file for each component of the complex system, said file comprising a description of the operations and data, incoming and outgoing to and from the component;
generating of a description file for an assembly of the components to form the complex system;
generating a description file for a deployment of the executables corresponding to the components on the processors of the platforms;
generating a file for mapping components with executable tasks, each task corresponding to at least one component, based on the component description, assembly description and deployment description files;
generating software code for containers of the components, each component being encapsulated by a container, said container comprising all the interfaces between the component and the complex system and between the component and the other components, based on the file for mapping the components with executable tasks;
generating executable tasks software code corresponding to the components and to the containers;
producing the executables by assembly of the executable task code, the component containers code and the code of the components associated with each executable; and
implementing the executables on the processors of the platforms on the basis of the mapping file.

2. The method according to claim 1, further comprising a step of checking the syntax and semantics of the component description files, assembly description files, deployment description files.

3. The method according to claim 1, further comprising a step of checking consistency between the component, assembly and deployment description files.

4. The method according to claim 2, further comprising a step of modifying the component, assembly and deployment description files when a file consistency error is detected during the consistency checking step or during the step for checking the syntax and semantics of the abovementioned files.

5. The method according to claim 1, wherein the generated files follow a predefined grammar.

6. The method according to claim 1, wherein the files are generated in xml format, xml being an acronym for Extensible Markup Language.

7. The method according to claim 6, wherein the xml files are generated according to an xsd model, xsd being an acronym for xml Schema Description.

8. A device for deploying components of a complex system on at least one platform comprising one or more processors, the device comprising:
means for generating a component description file for each component of the complex system, said file comprising a description of the operations and data, incoming and outgoing to and from the component;
means for generating a description file for an assembly of the components to form the complex system;
means for generating a description file for a deployment of the executables corresponding to the components on the processors of the platforms;
means for generating a file for mapping the components with executable tasks, each task corresponding to at least one component, based on the component description, assembly description and deployment description files;
means for generating software code for containers of the components, each component being encapsulated by a container, said container comprising all the interfaces between the component and the complex system and between the component and the other components, based on the file for mapping the components with executable tasks;
means for generating executable tasks corresponding to the components and to the containers;
means for producing executables by assembly of the executable task code, the component container code and the code of the components associated with each executable; and
means for implementing executables on the processors of the platforms on the basis of the mapping file.

9. The device according to claim 8, further comprising means for checking the syntax and semantics of the component description files, the assembly description file and the deployment description file.

10. The device according to claim 8, further comprising means for checking consistency between the component, assembly and deployment description files.

11. A method for evaluating performance levels in a deployment of components of a complex system on at least one platform comprising one or more processors, said method comprising the steps of:
generating a component description file for each component of the complex system, said file comprising a description of the operations and data, incoming and outgoing to and from the component, said file describing a modeling of the operation of the component in terms of processing time;
generating a description file for an assembly of the components to form the complex system;
generating a description file for a deployment of the executables corresponding to the components on the processors of the platforms;
generating a file for mapping the components with executable tasks, each task corresponding to at least one component, based on the component description, assembly description and deployment description files;
generating a description file of a scenario for execution of a simulation of the complex system, implementing the modelings of the components;
virtual execution of the scenario and time analysis of the processing operations carried out by the modeled components; and
inclusion of the analysis in the description of the components, of the assembly of the components, of the deployment of the components of the complex system.

12. A device for evaluating performance levels in a deployment of components of a complex system on a platform comprising a number of processors, the device comprising:
means for generating a component description file for each component of the complex system, said file comprising a description of the operations and data, incoming and outgoing to and from the component, said file describing a modeling of the operation of the component in terms of processing time;
means for generating a description file for an assembly of the components to form the complex system;
means for generating a description file for a deployment of the executables corresponding to the components on the processors of the platforms;
means for generating a file for mapping components with executable tasks, each task corresponding to at least one component, based on the component description, assembly description and deployment description files;
means for generating a description file of a scenario for execution of a simulation of the complex system, implementing the modelings of the components;
means for virtual execution of the scenario and time analysis of the processing operations carried out by the modeled components.
